(19) United States
(12) Patent Application Publication
(10) Pub. No.: US 2013/0126529 A1
(43) Pub. Date: May 23, 2013

(54) VENTED BEVERAGE CAN END

(71) Applicants: Emily Nesling, Banbury (GB); Ezekiel Johnson, Brookfield, IL (US); Brendan Keane, Deerfield, IL (US); Jan Dvorak, Wheaton, IL (US)

(72) Inventors: Emily Nesling, Banbury (GB); Ezekiel Johnson, Brookfield, IL (US); Brendan Keane, Deerfield, IL (US); Jan Dvorak, Wheaton, IL (US)

(73) Assignee: Crown Packaging Technology, Inc., Alsip, IL (US)

(21) Appl. No.: 13/504,285

(22) PCT Filed: Oct. 29, 2010
(86) PCT No.: PCT/US10/54698

§ 371 Date: Jul. 11, 2012

Related U.S. Application Data
(60) Provisional application No. 61/256,609, filed on Oct. 30, 2009.

(51) Int. Cl. B65D 51/16; B21D 24/00; B67B 7/00

(52) U.S. Cl. CPC B65D 51/1672; B67B 7/00; B21D 24/00
USPC 220/271; 53/492; 413/69

(57) ABSTRACT

A beverage can end for seaming onto a can body may include a peripheral wall, a center panel, a tab attached to the center panel by a rivet (56), a tear panel (41b), a main reference line (RM), a transverse reference line (RT), and a score (31b). The score may include arcuate main score (31b) that defines a main portion of the tear panel (41b) and a score extension (32b) that defines a vent portion. The score may be configured such that actuation of the tab from its horizontal rest position to an intermediate position ruptures the main score portion (31b) to pivot the tear panel main portion (40b) about the hinge and further actuation of the tab by twisting from the intermediate position ruptures the score extension (32b).

### TECHNICAL FIELD

The present invention relates to metal packaging, and more particularly to optionally vented openings in metal beverage can ends.

### BACKGROUND

Aluminum beverage cans are produced in vast quantities. Conventional beverage cans include a one-piece, drawn and ironed body and an end that is attached to a flange of the can body by a double seam. A can end, in its unseamed state, has a peripheral curl for seaming to the can body flange, a wall extending from the curl (that is, a chuck wall), an annular bead (that is, a countersink), or like structure extending from the wall and a center panel.

Conventional center panels have a score that defines a tear panel and a tab that is attached to the center panel by a rivet. The score has first and second ends that define a hinge about which the tear panel actuates. In the vast majority of commercial ends, the hinge is not centered relative to the score and tear panel, but rather is located to a side. The score extends from its first end in front of the rivet about a curved path to its second end. Conventional large opening ends (LOE) have an elongated opening, as shown in FIG. 1A (Prior Art).

Commercial ends of the type shown in FIG. 1A are opened only by lifting the heel of the tab to force the tab nose against the tear panel. The downward force initiates an initial venting, which is promoted by a check slot, and the downward force then displaces the tear panel and ruptures the remainder of the score to form an opening.

Pouring from conventional beverage cans creates unsteady state flow or “glugs,” as described in U.S. patent application Ser. No. 09/857,145, which is assigned to the assignee of the present invention.

U.S. Pat. Nos. 6,354,453; 6,079,583; 5,555,992; 5,011,037; and 3,977,561 disclose can ends that have been purported to create a vent after opening. There is a need for improved can end configurations that promote venting after opening of the tear panel.

### SUMMARY

A beverage can end, a method of opening a beverage can end, and a system for forming a score in a beverage can end are disclosed. A beverage can end for seaming onto a can body may include a peripheral wall, a center panel, a tab attached to the center panel by a rivet, a tear panel, a main reference line, a transverse reference line, and a score. The tear panel may include (i) a main portion capable of pivoting about a hinge and (ii) a vent portion. The main reference line may bisect the tear panel main portion and may extend through the rivet, the hinge being offset relative to the main reference line. The transverse reference line may be perpendicular to the main reference line and may extend through the rivet, the main portion of the tear panel being located in front of the transverse reference line. The score may include arcuate main score that defines the main portion of the tear panel and a score extension that defines the vent portion.

Preferably, the score extension defines an arc that generally corresponds to the path of the tab when twisted in the further actuation from the intermediate position, such as a curved profile. Also, the score may be configured such that the actuation from the intermediate position is optional. Preferably, the main portion of the tear panel is elongated in a transverse direction and has an aspect ratio of between 1.3 and 1.7.

The main reference line and the transverse reference line preferably divide the center panel into first and second front quadrants and first and second rear quadrants, the score extends (i) from the score first end in the first front quadrant across to the main reference line near the rivet to extend into the second front quadrant, (ii) in an arcuate path in the second front quadrant, (iii) across the main reference line near the front-most portion of the center panel, (iv) in an arcuate path in the first front quadrant, and (v) to an intermediate point located in the first front quadrant and defining an end of the hinge opposite the score first end.

The score extension extends from the intermediate point across the transverse reference line into the first rear quadrant. The hinge is defined between the score first end and an intermediate point on the score, which is at the base of the score extension. Preferably the score extension is no longer than three times the length of the hinge, and even more preferably the score extension is no longer than two times the length of the hinge.

A first end of the score (i) may define one end of the hinge and (ii) may be located on the hinge-side of the main reference line and in front of the transverse reference line. A second end of the score (1) may define one end of the score extension and (ii) may be located on the hinge-side of the main reference line and to the rear of the transverse reference line. The score may be configured such that actuation of the tab from its horizontal rest position to an intermediate position ruptures the main score portion to pivot the tear panel main portion about the hinge, and further actuation of the tab by twisting from the intermediate position ruptures the score extension. The score extension may optionally define an arc that generally corresponds to the path of the tab when twisted in the further actuation from the intermediate position.

A method of opening a beverage can end may include the steps of providing a beverage can including a can body and an end attached to the can body by a double seam; lifting a heel of the tab from its initial, horizontal position; and twisting, after the lifting step, the tab to rupture an extension of a score. The can end may include a peripheral wall, a center panel, and a tab attached to the center panel by a rivet. The center panel may include a tear panel that is formed by a score and may define a main reference line that bisects a main portion of the tear panel. Lifting a heel of the tab from its initial, horizontal position may force a nose of the tab against the tear panel until the score ruptures and the tear panel main portion pivots about a hinge that extends from a first end of the score. The first end of the score may be located in front of the main reference line and on the hinge-side of a transverse reference line. The score may be configured such that actuation of the tab from its horizontal position to an intermediate position ruptures the main score portion to open the tear panel main portion and further actuation of the tab by twisting from the intermediate position ruptures the score extension to open the panel vent portion. The score extension may optionally define an arc that generally corresponds to the path of the tab when twisted in the further actuation from the intermediate position.

A system for forming a score in a beverage can end may include an upper score cap having a main score protrusion and a score extension protrusion and a lower score cap having an uninterrupted anvil surface extending at least to the corresponding location of the score extension protrusion of the upper score cap. The upper score cap and the lower score cap may be configured to press together such that the main score protrusion forms a main score in the beverage can end and the score extension protrusion forms a score extension in the beverage can end. The main score and the score extension may be configured such that actuation of a tab coupled to the can end from its horizontal position to an intermediate position ruptures the main score portion to open a tear panel main portion and further actuation of the tab by twisting from the intermediate position ruptures the score extension to open a panel vent portion. The score extension may optionally define an arc that generally corresponds to the path of the tab when twisted in the further actuation from the intermediate position.

These and various other advantages and features are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there are illustrated and described preferred embodiments of the invention.

### BRIEF DESCRIPTION OF THE DRAWINGS

FIG. 1A (Prior Art) is a top plan view of a conventional beverage can;

FIG. 1B (Prior Art) is a top plan view of a beverage can end including a conventional large opening end and a venting structure;

FIG. 2 is a partial perspective view of a beverage can end seemed to a can body illustrating a first embodiment of the present invention;

FIG. 3 is a partial cutaway top plan view of a tear panel according to a second embodiment of the present invention;

FIG. 4A is a top plan view of a an unseamed beverage can end in an unactuated state according to the second embodiment of the present invention;

FIG. 4B is a perspective view of the end of FIG. 4A in a partially actuated state;

FIG. 4C is a top plan view of the end of FIG. 4A in a fully actuated, vented state;

FIG. 5A is a top plan view of a beverage can end according to the first embodiment of the present invention;

FIG. 5B is a top plan view of a beverage can end according to a third embodiment of the present invention;

FIG. 6A is a graph showing the flow rate of four different can end designs, each having a different-shaped score design;

FIG. 6B is a graph showing a running average of the instantaneous flow rate of the four different can end designs depicted in FIG. 6A;

FIG. 7A is a perspective view of an upper score cap suitable for use to form the first embodiment scores depicted in FIG. 5A;

FIG. 7B is a perspective view of an upper score cap suitable for use to form the third embodiment scores depicted in FIG. 5B; and

FIG. 8 is a top view of a lower score cap suitable for use to form the first or third embodiment scores depicted in FIGS. 5A and 5B.

### DETAILED DESCRIPTION OF ILLUSTRATIVE EMBODIMENTS

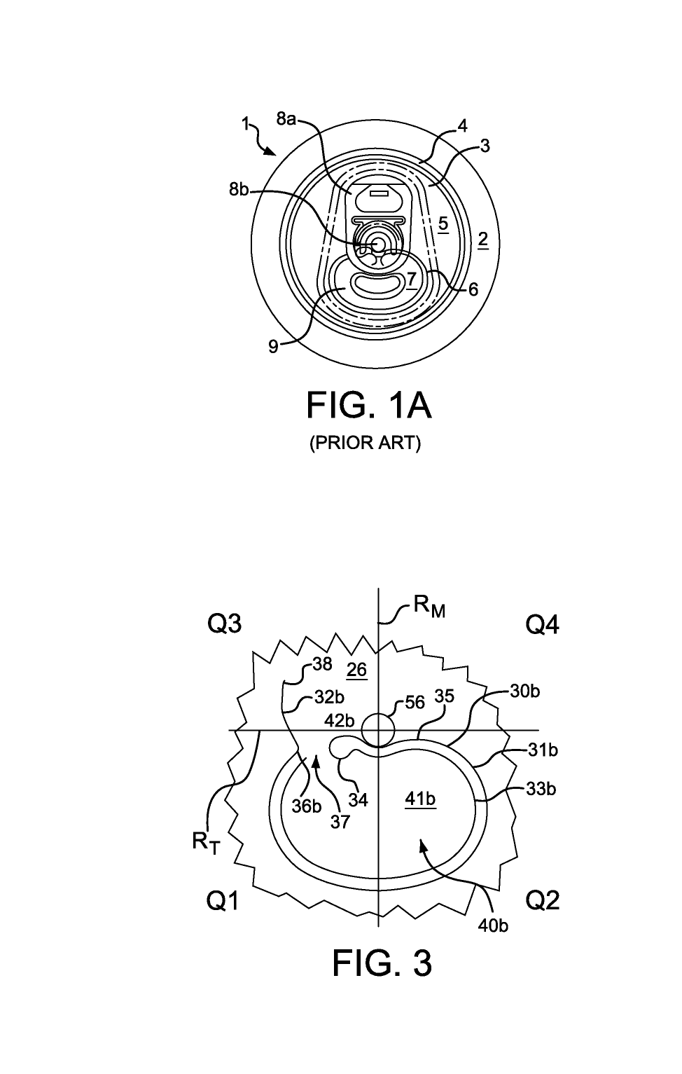

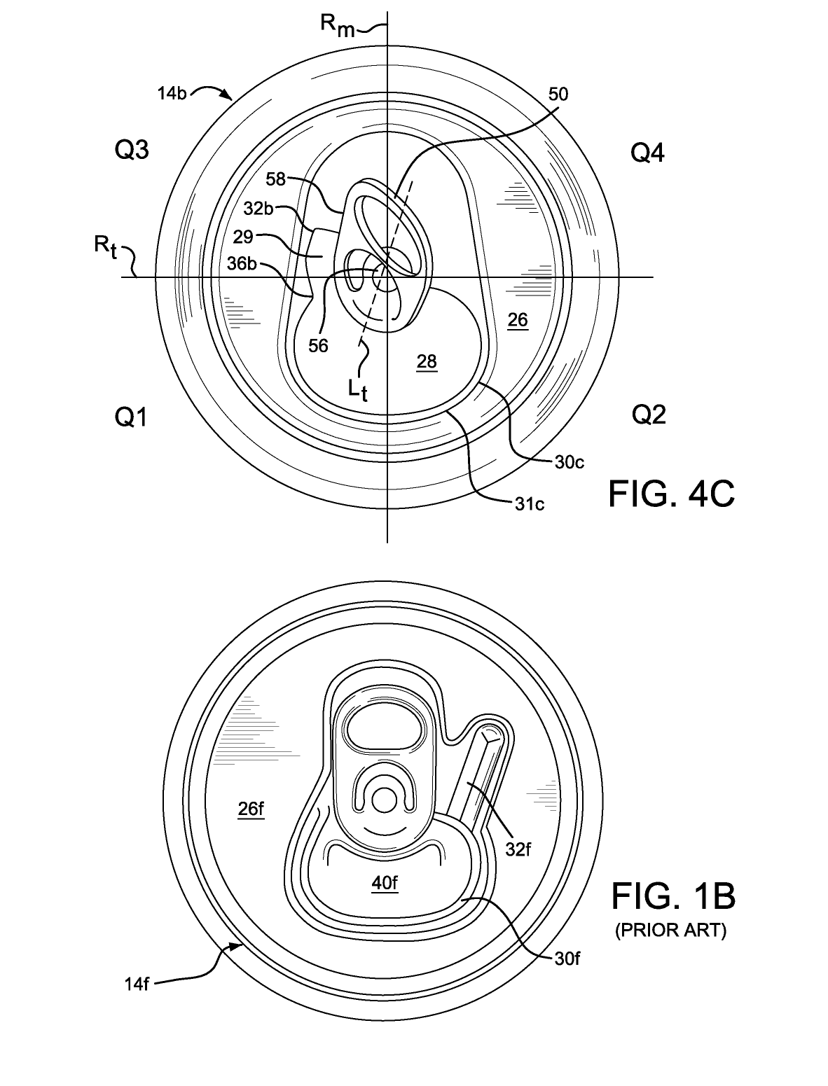

Referring to FIG. 1A (prior art), a prior art beverage can 1 includes a can body 2 and a conventional large opening end (LOE) 3. The can end 3 is attached to the can body 2 by a conventional double seam 4. The can end 3 includes a center panel 5. The center panel 5 has a score 6 that defines a tear panel 7 and a tab 8a that is attached to the center panel 5 by a rivet 8b. When the tear panel 7 is actuated, the score 6 defines an opening 9 through which the contents of the can 1 may be poured.

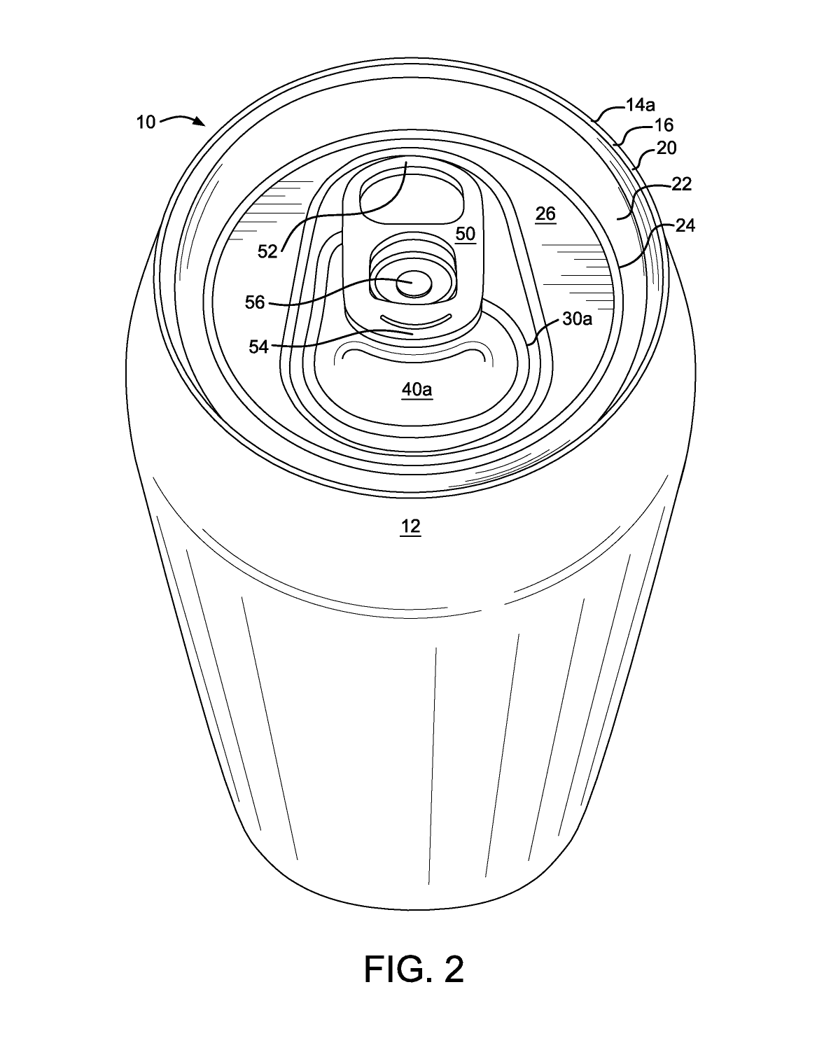

Referring to FIG. 2, a beverage can 10 illustrating a first embodiment of the present invention includes a can end 14a attached to a can body 12. The can body 12 preferably is formed of aluminum by a drawing and ironing process. The can end 14a shown in FIG. 2 is preferably is attached to can body 12 by a conventional double seam 16.

The can end 14a has a generally circular shape with a rivet 56 located at or near the center of the can end 14a. A chuck wall 22 extends inwardly and downwardly from seam 16 to an annular bead or countersink 24. Countersink 24 connects the center panel 26 and the chuck wall 22, extending downwardly into the chamber of the can body and away from the center panel 26. The can end 14a may be formed of a shell having any configuration, several of which are currently known. Reference numeral 20 in FIG. 2 is used to illustrate the position of a portion of the curl of the unseamed can end. Can end 14a includes a score 30a formed on center panel 26, as described more fully below.

The first embodiment of the score (30a) is employed in FIG. 2 to illustrate the combination of the can end with the can body. FIG. 3 depicts a top view of a portion of a can end 14b according to a second embodiment of the present invention. End 14b is illustrated in its unseamed state, and it is understood that the present invention encompasses can ends that are unseamed, seamed can ends, and the combination of a seamed can end and can body.

End 14b includes a center panel 26 having a score 30b. Score 30b includes main score 31b and a score extension or vent score 32b, which scores define a displaceable tear panel 40b having a main portion 41b and a vent portion 42b. To aid in the description of the location of portions of the score 30b, a main reference line R_{M} is defined as bisecting the main portion 41b of the tear panel 40b and extending through the center of the rivet 56. A transverse reference line R_{T} is defined as perpendicular to the main reference line R_{M} on the center panel 26 and extending through the center of the rivet 56. For tear panels having a main portion that is asymmetrical (not shown), line R_{M} may be drawn through the rivet to divide the area of the main portion of the tear panel into equal areas. The transverse reference line R_{T} defines the front and rear directions or locations. The side of the transverse reference line R_{T} on which main portion 41b of tear panel 40b is located is referred to as the front of can end 14b, and the opposing side is referred to as the rear. The reference lines R_{M} and R_{T} form first and second front quadrants Q1 and Q2 and first and second rear quadrants Q3 and Q4. When the front of the can end 14b is depicted below the rear of the can end 14b as shown in FIG. 3, Quadrants Q1 and Q3 are located on the left side (also referred to as the hinge side) of the main reference line R_{M} and quadrants Q2 and Q4 are located on the opposing right side of the main reference line R_{M}. In this way, the transverse reference line R_{T} defines directions left and right.

The shape and location of the main score 31b relative to the main reference line R_{M} and the transverse reference line R_{T} will now be described. Main score 31b extends from a first end 34 of main score 31b, which preferably is located to the front and side of the rivet 56 in the front left quadrant Q1. Main score 31b extends across main reference line R_{M} near and in front of the rivet 56 into front right quadrant Q2 in an arcuate path. A check slot 35, which temporarily stops or inhibits the opening of the main score 31b near the rivet 56 to allow for initial venting of the beverage can 10, may be located in the main score 31b near the rivet 56. Accordingly, a portion of score 31b near end 34 functions as a conventional vent.

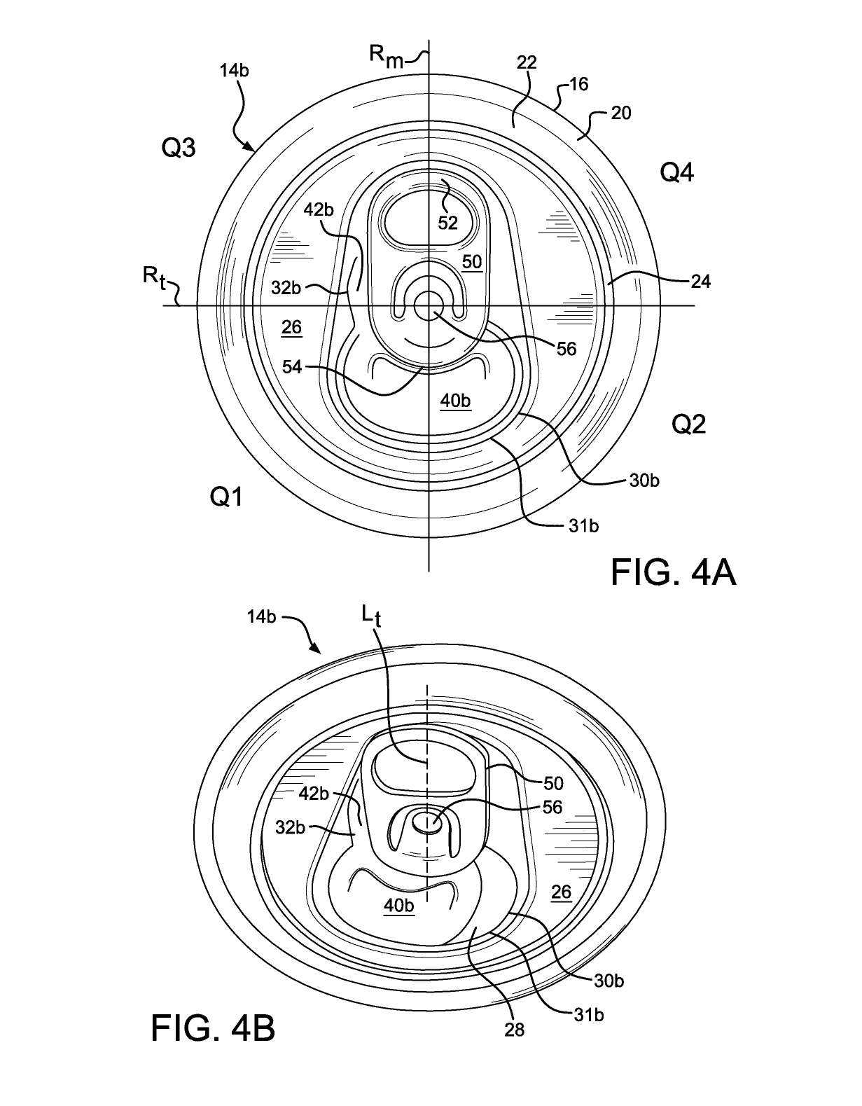

Past the check slot 35, the main score 31b continues in an arcuate path through Q2, the extent of which defines a side of the main portion 41b of the tear panel 40b, and again crosses the main reference line R_{M} and into the front left quadrant Q1 near the chuck wall 22 and near the front-most portion of the center panel 26. In the embodiment shown in FIG. 3, the main score 31b continues from the front of center panel 26 through the front left quadrant Q1 in an arcuate path until the main score 31b approaches and extends to an intermediate point 36b. Preferably, intermediate point 36b is located in the front left quadrant Q1 on the front side of the transverse reference line R_{T} and on the same side of the main reference line R_{M} as the score first end 34. Because main score 31b extends toward main reference line R_{M} after forming the left-most portion of main panel portion 41b, and score extension 31b extends from intermediate point 36b on a curved path that has a leftward component (as viewed in FIG. 4A), intermediate point 36b is formed on a peninsula-like protrusion that forms a point and roughly triangular shape.

A hinge 37 is defined between the score first end 34 and the intermediate point 36b. Hinge 37 defines the boundary of main portion 41b of tear panel 40b and defines the structure about which the main portion 41b of the tear panel 40b pivots when the tear panel 40b is opened. In the first, second, and third embodiments shown in FIGS. 2 through 5B, the hinge 37 is located on the front side of the transverse reference line R_{T} and on the hinge side (also the left side in the figures) of the main reference line R_{M} in quadrant Q1. While hinge 37 has been described in relation to the first end 34 and the intermediate point 36b of the second embodiment, it will be appreciated that in the first and third embodiments, the hinge 37 extends from the first end 34 to the intermediate points 36a,c, respectively.

Again referring to FIG. 3, a score extension 32b extends from intermediate point 36b. Score extension 32b extends towards the rear of the can end 14b from the intermediate point 36b past the transverse reference line R_{T} and into the rear left quadrant Q3, without crossing the main reference line R_{M}, to terminate at a second end 38 of the score 31b. As shown, the score extension 32b may have a hook-shape or curvature.

FIG. 3 also shows an anti-fracture score 33b extending along the main score 31b. The anti-fracture score 33b preferably extends along main score 31b and/or the score extension 32b and is offset from the main score 31b and/or the score extension 32b. All scores described herein may be formed by conventional methods. Preferably, the main portion 41 of tear panel 40 has the dimensions of conventional large opening ends configured as well-known DRT or Stolle-style configurations.

FIG. 4A shows combination can body 12 and can end 14 with the score configuration of FIG. 3. A tab 50 for opening the tear panel 40b is attached to the center panel 26 by rivet 56. Tab 50 includes a heel 52 at its rear end and a nose 54 at its front end. When the tear panel 40b is actuated, score 30b defines a portion of the main opening 28 (shown in FIG. 4B) through which the contents of the can 10 may be poured, and at least a portion of a vent opening 29 (shown in FIG. 4C) through which air can flow into the can 10 to allow for faster and smoother pouring of a beverage through the main opening 28. Hinge 37 defines another portion of the boundary of main opening 28.

As shown in FIGS. 3, 4A, 4B, and 4C, score extension 32b preferably is curved to approximately follow an arc defined by the actuation of tab 50, as explained more fully below. In this regard, the score extension 32b may have a radius that is approximately equal to or slightly larger than the radius of the arcuate path of the leading edge 58 (best shown in FIG. 4C) of the tab 50. For example, the score extension 32b may be formed of a single or gradually changing arcs that are no greater than about 130% of the radius of the arc of tab actuation, preferably no greater than about 120%, more preferably less than about 110% of the radius of the arc of tab actuation. In this regard, the arc of the tab actuation may be defined as the movement in space of the outermost portion of tab 50 as its is twisted from its intermediate position of FIG. 4B to its actuated position of FIG. 4C. The arc preferably is defined in the plane of center panel 26. Also, score extension 32b preferably is no longer than three times the length of the hinge, and more preferably no longer than two time the length of the hinge. The present invention is encompasses other shapes of the score extension.

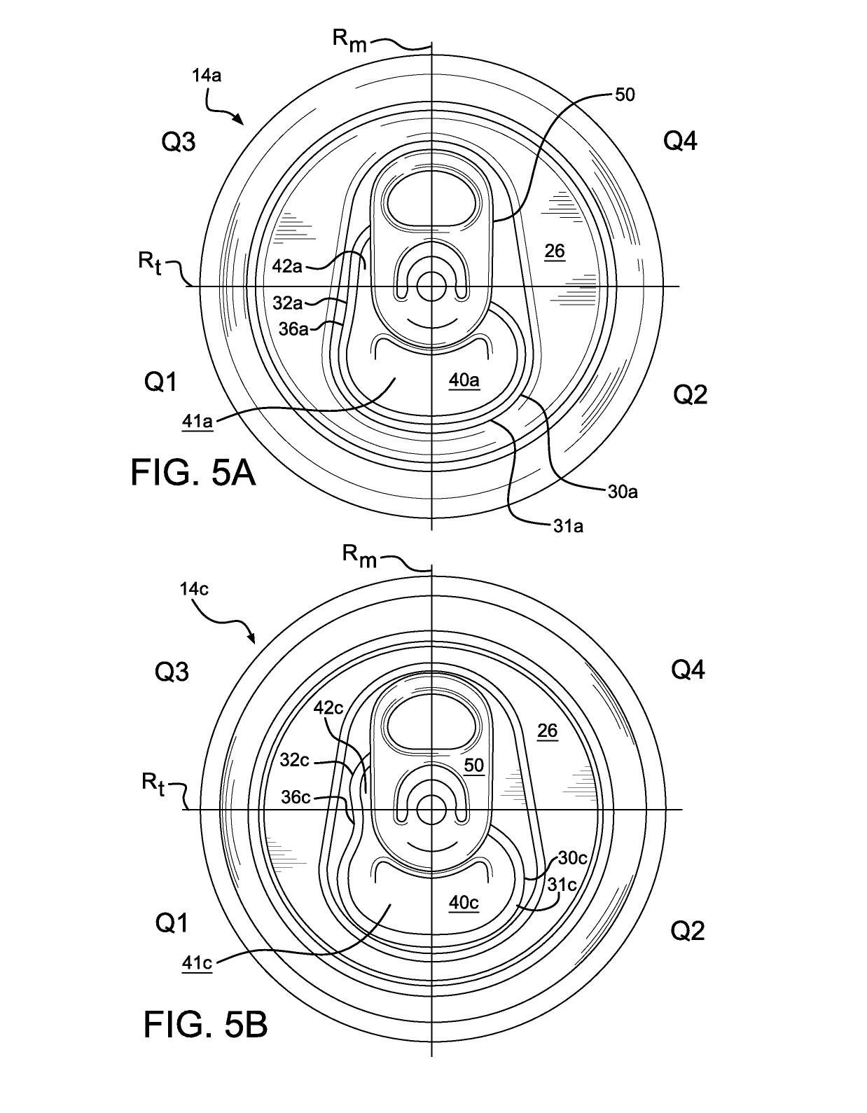

FIG. 5A illustrates a first embodiment of the score 30a (shown in FIG. 2). First embodiment score 30a includes a main score 31a and a score extension 32a, both formed in the center panel 26. Scores 31a and 32a define a displaceable tear panel 40a having a main portion 41a and a vent portion 42a. Tab 50 is attached to center panel 26 by rivet 56. The description of main portion 41a and tear panel 40a is the same as that for second embodiment main panel portion 41b. Second embodiment score extension 32a extends from an intermediate point 36a on the score.

First embodiment main score 31a is as described for second embodiment main score 31b with respect to its shape from end 34 (not shown in FIG. 5A because end 34 is below tab 50) through quadrant Q2. Main score 31a extends from quadrant Q2 in its arcuate path through quadrant Q1 to define the left-most part of main panel portion 41a. Main score 31a extends around the leftward-most part of main panel portion 41a and extends rearward, then extends rearwardly and rightwardly with only a slight inward curvature (that is, convex when viewed from the hinge-side of the end). Intermediate point 36a is formed on the inwardly bowed portion of the score. In embodiments in which the location of the intermediate point it is unclear from the shape of the score, the intermediate point may be defined as the portion of the score the forms the end of the hinge opposite end 34. Intermediate point 36a preferably is in quadrant Q1—forward of transverse line R_{T} and on the left or hinge side of main reference line R_{M}.

Score extension 32a extends towards the rear of the can end 14a from the intermediate point 36a past the transverse reference line R_{T} and into the rear left quadrant Q3, without crossing the main reference line R_{M}. Score extension 32a terminates at a second end 38 of the score 30a. As shown, the score extension 32a may have a hook-shape or curvature that extends inwardly toward main reference line R_{M}. Preferably, score extension 32a has an arcuate shape as described above with respect to second embodiment score extension 32b.

Preferably, the upper portion (that is, distal from intermediate point 36a) has curvature and dimensional relationships that are as described for second embodiment score extension 32b, such that (for example) the tail portion of score extension 32a has a radius that is approximately equal to or slightly larger than the radius of the arcuate path of the leading edge 58 of the tab 50, and a length as described above.

FIG. 5B depicts a third embodiment of the score 30c on a can end 14c. Third embodiment score 30c includes a main score 31c and a score extension 32c and is formed in the center panel 26. Main score 31c and score extension 32c define a displaceable tear panel 40c having a main portion 41c and a vent portion 42c. Tab 50 is attached to center panel 26 by a rivet 56. The description of main portion 41a tear panel 40a is the same as that for second embodiment main panel portion 41b except for intermediate point 36c and the portion of score 31c near intermediate point 36c. Third embodiment score extension 32c extends from an intermediate point 36c on the score.

Third embodiment main score 31c is as described for second embodiment main score 31b with respect to its shape from end 34 (not shown in FIG. 5B because end 34 is below tab 50) through quadrant Q2. Main score 31c extends from quadrant Q2 in its arcuate path through quadrant Q1 to define the left-most part of main panel portion 41c. Main score 31c extends around the leftward-most part of main panel portion 41c and extends rearward, then extends rearwardly and rightwardly with an inward curvature (that is, convex when viewed from the hinge-side of the end) to form a waist. Intermediate point 36c is formed on the inwardly bowed portion or waist portion of the score. Intermediate point 36c preferably is in quadrant Q1—forward of transverse line R_{T} and on the left or hinge side of main reference line R_{M}.

Score extension 32c, from intermediate point 36c, extends away from main reference line R_{M} and toward the rear of the can end 14c, thereby forming a protruding portion of the center panel and the waist on which intermediate point 36c is defined. Score extension 32c continues to extend past the transverse reference line R_{T} and into the rear left quadrant Q3, without crossing the main reference line R_{M}. Score extension 32c terminates at a second end 38 of the score 30c. As shown, the score extension 32c has a hook-shape or curvature that extends inwardly toward main reference line R_{M}. Preferably, score extension 32c has an arcuate shape as described above with respect to second embodiment score extension 32c.

Preferably, the curvature of the upper portion of score extension 32c (that is, distal from intermediate point 36c) has curvature and dimensional relationships that are as described for second embodiment score extension 32b, such that (for example) the tail portion of score extension 32c has a radius that is approximately equal to or slightly larger than the radius of the arcuate path of the leading edge 58 of the tab 50, and a length as described above.

The main scores 31a,b,c of the three embodiments shown in FIGS. 2 through 5B (the use of more than one reference letter after a reference numeral will be used in the description to indicate that the text refers to the embodiments corresponding to the reference letters) may have the same depth and cross-sectional shape as the score 6 in a conventional large opening end 3 (shown in FIG. 1A). For example, the score residual for the main score 31b may be approximately 0.0034 to 0.0043 inches. Alternatively, the three embodiments of the main score 31a,b,c may have a thicker score residual than the score 6 in a conventional large opening end 3 (e.g., for increased score strength).

In the embodiments shown in figures, all of the main scores 31a,b,c and the main portions 41a,b,c of the tear panels 40a,b,c do not extend rearward of the transverse reference line R_{T}. The present invention is not limited to such structure, but rather the claims provide the full measure of the scope of the present invention.

The score extensions 32a,b,c preferably have the same depth and cross-sectional shape as the main score 31a,b,c. In some embodiments, including for example, when it is desired to increase the pressure at which the score 30a,b,c bursts, the score extensions 32a,b,c may have a thicker score residual than main score 31a,b,c.

The score 30a,b,c may include a second conventional check slot at or near the intermediate point 36a,b,c to help strengthen the main score 31a,b,c and/or the score extension 32a,b,c, which may enhance (that is, enable higher) the internal pressure performance or rating of the can. The score 30 may include a gap (not shown) at or near the intermediate point 36 to help strengthen the main score 31 and/or the score extension 32 for enhancing pressure performance or rating. The gap preferably is a portion of center panel 26 that has its full thickness such that portions of the score are space apart.

To describe the operation of the can ends described herein, and to explain the method steps according to an aspect of the present invention, FIGS. 4A, 4B, and 4C illustrate the opening and venting function of end 14b. While FIGS. 4A through 4C illustrate the second embodiment end 14b, the description of the opening and venting process provided in the description also applies to the opening and venting of the first embodiment (shown in FIGS. 2 and 5A) and the third embodiment (shown in FIG. 5B). Accordingly, starting with the can end 14b in an un-actuated, at-rest state, in which score 30b is intact and tab 50 is approximately parallel to a plane defined by center panel 26 or the upper rim of double seam 16, as shown in FIG. 4A, an end user begins the opening process by lifting the tab heel 52. In response, the tab 50 pivots about rivet 56 and induces deflection of the rivet 56 to force tab nose 54 against the main panel portion 41b when the tab is inclined approximately 20 degrees from the horizontal.

Most scores are configured such that main score 31b ruptures first in a short region near the rivet 56 and near first score end 34, and check slot 35 temporarily stops or slows propagation of the rupture of main score 31b. As the end user continues to lift tab heel 52, the force applied by the nose 54 against the main panel portion 41b increases until the rupture of the main score 31b begins (or check slot 35 is overcome, which occurs typically when tab 50 is inclined at approximately 70° relative to the center panel 26 or the rim of seam 16 or the horizontal) and then the rupture of the main score 31b propagates about the main portion 41b of the tear panel 40b until score propagation stops at or near intermediate point 36b.

FIG. 4B depicts can end 14b in a partially actuated state, upon completion of the first stage of opening of the score 30b. The main portion 41b of the tear panel 40b has pivoted about the hinge 37 to form the main opening 28. Tab 50 is generally upright such that tab 50 is oriented approximately 90° from its rest position and relative to center panel 26 or the rim of seam 16. A horizontal line L_{T} in the plane defined by the tab 50, running the length of the center of the tab, is approximately perpendicular to the transverse reference line R_{T}.

After the can end 14b has been positioned in the partially actuated state shown in FIG. 4B, a user may pour a beverage through the main opening 28 in the conventional way. If a user is does not understand or appreciate the additional venting structure 42b and how to actuate the second stage of the opening process, or desires not to use the additional venting structure or capabilities, the user need do nothing more except pushing heel 52 back to its at-rest position. Thus, the user may use end 14b in a conventional way, thereby ignoring the additional venting capabilities of the can end 14b. Alternatively, the user may (optionally) perform additional actuation of the tab 50 to open a vent opening 29 for faster and smoother pouring of a beverage through the main opening 28. Opening the vent opening 29 may allow a user to pour a beverage through the main opening 28 more quickly, in many embodiment approximately twice as quickly, compared with leaving the vent opening 29 closed.

FIG. 4C depicts the can end 14b in a fully actuated, vented state. To perform the second opening stage to get end 14b to its fully actuated state, a user grasps and twists the tab heel 52 to create a moment about the horizontal line L_{T}. In the orientation of the Figures, the user pivots tab 50 clockwise (roughly) about the horizontal line L_{T} to rupture score extension 32. More specifically, the leading edge of the tab 50 engages the vent portion 42b of the tear panel 40b initially at or near the hinge 37 under moment from the user's twisting until the score extension 32b ruptures at or near the intermediate point 36b. The rupture then propagates along the score extension 32b toward the second end 38 of the score 30b.

The displacement of the vent portion 42 from the plane of the center panel 26 to create the vent opening 29 provides venting (an opening through which air can flow into can 10) during pouring of a beverage through the main opening 28, which may reduce “glugging” and which may provide relatively smooth flow or diminish the magnitude of flow rate variations of the unsteady state flow of a beverage through the main opening 28.

Referring to FIG. 1B (prior art), a prior art can end 14f includes a circular center panel 26f. A score 30f and a vent channel 32f are formed in center panel 26f, and the score 30f defines a displaceable tear panel 40f. The can end 14f is produced by Ball Corporation for Coors Brewing Company.

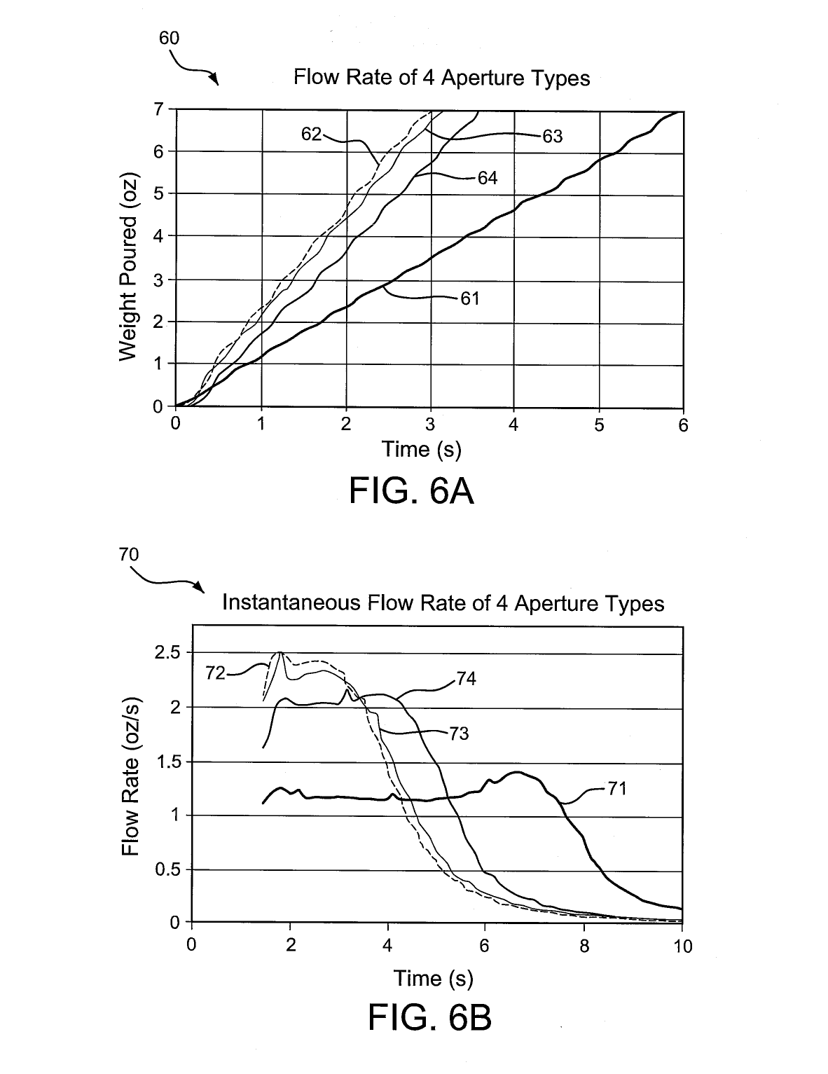

Referring to FIG. 6A, a graph 60 shows the weight of liquid poured from various can ends over time during an initial flow rate period (that is, after which the flow rate slows down once most of the liquid has already poured out of the can). The four score shapes tested to produce graph 60 are score 6 (FIG. 1A, Prior Art), score 30a (FIG. 5A), score 30c (FIG. 5B), and score 30f (FIG. 1B, Prior Art), which are shown respectively as lines 61, 62, 63, and 64. The weight of liquid poured over time out of each of the can ends shows a comparison of these four score shapes in terms of which shapes allow the fastest peak pouring of liquid through the can end.

As can be seen in graph 60, lines 62 and 63 (representing inventive scores 30a and 30c, respectively) had the highest flow rates. Line 64 (representing score 300 and line 61 (representing score 6) had lower flow rates. Comparing the performance of the different score shapes and venting structures, it can be seen from the graph 60 that the two lift-and-twist score embodiments 30a and 30c had substantially faster flow rate performance than the conventional large opening end score 6 and the conventional large opening end score 30f with a vent channel. The average flow rates and projected time to pour 12 oz (at a constant flow rate) that can be calculated from graph 60 are shown below in TABLE 1.

TABLE 1

| | | | % Flow Rate |
|---|---|---|---|
| | Average Flow | Projected Time to | Improvement |
| Type of Score | Rate (oz/s) | Pour 12 oz (s) | over LOE |
| LOE (Prior Art) | 1.2 | 10.4 | — |
| LOE w/ Prior Art | 2.0 | 6.1 | 69% |
| Channel | | | |
| Lift-and-Twist 30c | 2.3 | 5.3 | 97% |
| Lift-and-Twist 30a | 2.4 | 5.0 | 106% |

Referring to FIG. 6B, a graph 70 shows the flow rate of liquid poured from a can end openings versus time. Each point on graph 70 shows the average flow rate of liquid poured during the previous 1.5 seconds such that graph 70 represents a running 1.5-second average flow rate of liquid poured. The initial portion of graph 70 correlates to the slope of the curves shown in graph 60, but graphs 70 shows data over a longer period.

The four score shapes tested to produce graph 70 are the same four score shapes tested to produce graph 60, which are: prior art score 6 (FIG. 1A), score 30a (FIG. 5A), score 30c (FIG. 5B), and prior art score 30f (FIG. 1B), which are shown respectively as lines 71, 72, 73, and 74. The flow rate of liquid poured out of each of the can ends can allow a comparison of which score shapes and venting structures allow the fastest total pouring of liquid through the can end.

As can be seen in the graph 70, lines 72 and 73 (representing scores 30a and 30c, respectively) had the highest initial running average flow rates. Line 74 (representing prior art score 30f) and line 71 (representing prior art score 6) had lower initial flow rates. Comparing the performance of the different score shapes and venting structures, it can be seen from the graph 70 that the inventors' two lift-and-twist score embodiments 30a and 30c had substantially faster initial running average flow rate performance than the conventional LOE score 6 and the conventional LOE score 30f with a vent channel. Although the running average flow rates of lines 72 and 73 (corresponding to embodiments of the present invention) dropped below that of lines 71 and 74 (prior art LOE scores) at approximately 4 seconds, this is because by 4 seconds, most of the liquid has already been poured out of scores 30a and 30c, so the last ounce or two of liquid pours out at a slower rate.

To understand how quickly the 12-oz volume is poured out of the various score types, the area under each of the curves 71-74 can be calculated. As can be seen from graph 70, the area under curves 72 and 73 are farthest to the left of graph 70, which means that the volume is poured out of scores 30a and 30c at an earlier point in time compared to the LOE scores. It can be seen from graph 70 that curves 72 and 73 drop below 0.5 oz/s at approximately 5 seconds, at which point there is less than 1 oz of liquid remaining in the can, while curve 74 drops below 0.5 oz at approximately 6 seconds, and curve 71 drops below 0.5 oz at approximately 8 seconds. Therefore, approximately the first 11 oz of liquid in cans having the lift-and-twist scores (curves 72 and 73) can be poured out 1 second faster than the conventional LOE score with a conventional venting structure (curve 74) and 3 seconds faster than the conventional LOE score alone (curve 71).

The two lift-and-twist score embodiments 30a and 30c depicted in FIGS. 5A and 5B were also tested for score performance. The first set of tests evaluated the break force and the tear force for each score design, using a score 30a or 30c residual of approximately 0.003 inches. Five cans of each score design were used for each test. The break force is the force required to open the part of the main score 31a or 31c near the rivet 56, before the check slot 35, to allow for initial venting of the beverage can. The tear force is the force required to propagate the opening of the main score 31a or 31c to the intermediate point 36a or 36c, thereby creating the main opening 28. For each can tested, the main score 31a or 31c residual was approximately the same as the score extension 32a or 32c residual, within a tolerance of ±0.0002 inches.

The average break force for the first embodiment score 30a was 3.2 lbs, and the average break force for the third embodiment score 30c was 3.7 lbs, both of which are sufficiently low for a user to be able to comfortably perform initial opening (typically, a value under 4.5 lbs is acceptable). The average tear force for the first embodiment score 30a was 3.8 lbs, and the average tear force for the third embodiment score 30c was 3.7 lbs, both of which are sufficiently low for a user to be able to comfortably propagate the opening of the main score 31a or 31c and create the main opening 28 (typically, a value under 5.5 lbs is acceptable).

The second set of tests evaluated the burst strength of each score design (this is a “loose buckle” test). Five cans of each score design were pressurized until part of the beverage can failed. The average pressure at which can ends including the first embodiment score 30a failed was 73.2 psi, and the average pressure at which can ends including the third embodiment score 30c failed was 68.1 psi. For pasteurized products such as beer, it is preferable that a can end withstand an internal pressure of 80 psi. In order to improve the burst strength, the inventors surmise that it would be beneficial to modify the design of the first embodiment score 30a and/or the third embodiment score 30c using one or more of the score-strengthening mechanisms discussed above.

All of the can ends in the second set of tests suffered “score burst,” rather than “peaking” of the can end. This means that the scores score 30a or 30c failed (score burst) before countersink 24 inverted at a point that forms a peak (that is, peaking). Peaking is a more desirable can end failure mode than score burst, so in order to change the failure mode from score burst to peaking, the inventors surmise that is may be beneficial to modify the design of the first embodiment score 30a and/or the third embodiment score 30c using one or more of the score-strengthening mechanisms discussed above.

A third set of tests evaluated the burst strength of three modifications of the first embodiment score 30a depicted. The three modifications included score 30 residuals of approximately 0.003 inches, 0.004 inches, and 0.005 inches, respectively. Ten cans of each modification were pressurized until part of the beverage can failed and began to reduce the pressure inside of each can. The average pressure at which can ends of each respective modification failed was 87.9 psi, 96.3 psi, and 95.9 psi for respective score 30f residuals of approximately 0.003 inches, 0.004 inches, and 0.005 inches. Given that for pasteurized products such as beer, it is preferable that a can end withstand an internal pressure of 80 psi, each of these modifications of the score performed sufficiently.

Regarding the failure mode of each modification, with the first modification having a score 30a residual of approximately 0.003 inches, eight can ends suffered “score burst,” and two can ends suffered “peaking and leaking” of the can end (that is, leaking from the peak formed upon failure).

Regarding the second and third modifications having the score 30a residuals of approximately 0.004 and 0.005 inches, respectively, eight can ends of each modification suffered “peaking” of the can end (i.e., having the can end 14a invert or pop up, moving about a hinge approximately located at the peripheral curl 20), and two can ends of each modification suffered “peaking and leaking” Conventional large opening ends such as the can end 3 depicted in FIG. 1A typically have the same rate of peaking and leaking as the second and third modifications, so there is little significant burst strength performance loss in these can ends compared to conventional large opening ends.

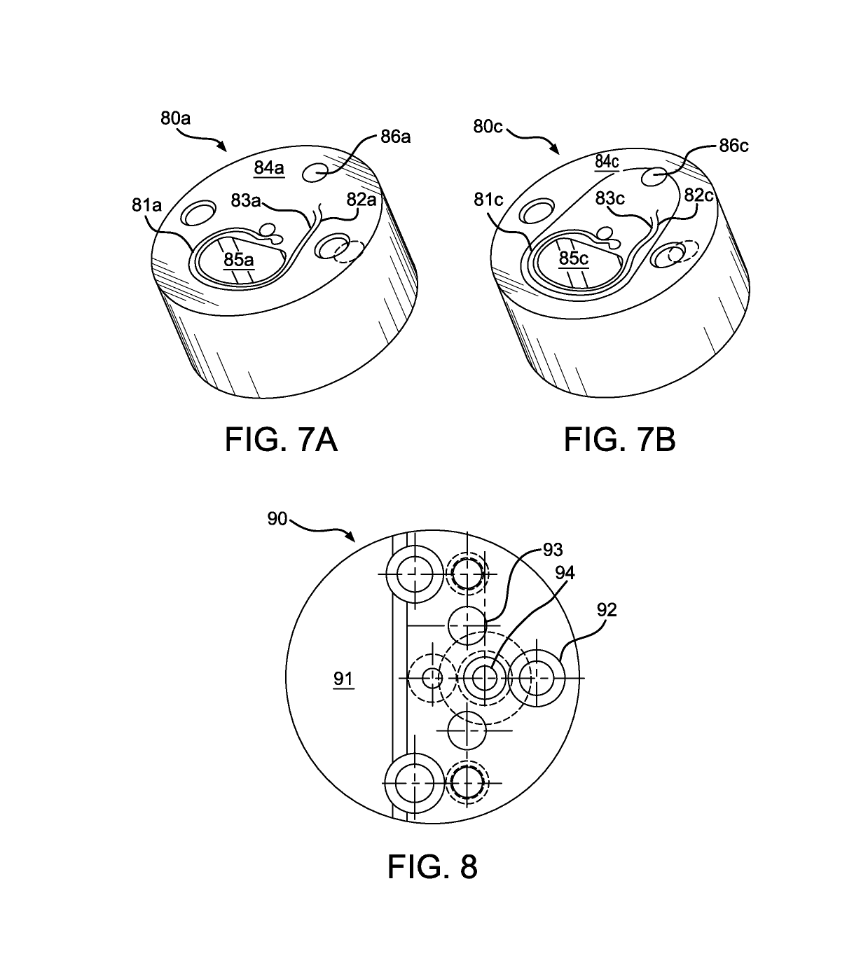

Referring to FIGS. 7A, 7B, and 8, an upper score cap 80a, suitable for use to form the first embodiment scores depicted in FIGS. 2 and 5A, includes a main score protrusion 81a, a score extension protrusion 82a, and an anti-fracture score protrusion 83a, each of which extends from an anvil surface 84a. The upper score cap 80a further defines a tear panel aperture 85a and a tool attachment aperture 86a that penetrates through the upper score cap 80a approximately perpendicularly to anvil surface 84a.

An upper score cap 80c, suitable for use to form the third embodiment scores depicted in FIG. 5B, includes a main score protrusion 81c, a score extension protrusion 82c, and an anti-fracture score protrusion 83c, each of which extends from an anvil surface 84c. The upper score cap 80c further defines a tear panel aperture 85c and tool attachment apertures 86c that penetrate through upper score cap 80c approximately perpendicularly to anvil surface 84c. A score cap (not shown in the figures) for the second embodiment score 30b would have the corresponding shape of score 30b located in the place on the cap similar to that shown in FIGS. 7A and 7B.

A lower score cap 90, suitable for use to form either of the first or third embodiment scores depicted in FIGS. 5A and 5B, includes an anvil surface 91 that defines a plurality of tool attachment apertures 92 that penetrate through the lower score cap 90 approximately perpendicularly to anvil surface 91.

The lower score cap 90 defines a location 93, at which an aperture is located in a conventional lower score cap, but at which there is no aperture present in the lower score cap 90, because the score extension protrusion 82a or 82c need to mate with a flat portion of anvil surface 91 to properly form the respective first or third embodiment score extension 30. To compensate for the absence of an aperture at location 93, the lower score cap 90 includes an enlarged aperture at a location 94 (compared to a smaller aperture at location 94 in a conventional lower score cap), so that lower score cap 90 can be securely coupled to and/or removed from other components of can end score forming equipment.

The score extensions of the lift-and-twist embodiments of the can ends shown in the Figures may only require relatively minor modifications to existing shell press and conversion tooling, such as the modifications to the locations of the apertures 92 in the lower score cap 90, to allow conventional shell press and conversion tooling to be used to produce the lift-and-twist embodiments of the can ends.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Further, several advantages have been described that flow from the structure and methods; the present invention is not limited to structure and methods that encompass any or all of these advantages. Those skilled in can end technology, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein. For example, any features or advantages related to the shape of the main score, score extension, and anti-fracture score with respect to discussion of a particular can end embodiment can be applicable to any of the other can end embodiments described herein.

What is claimed:

1. A beverage can end for seaming onto a can body, the can end comprising:
a peripheral wall;
a center panel;
a tab attached to the center panel by a rivet;
a tear panel including (i) a main portion capable of pivoting about a hinge and (ii) a vent portion;
a main reference line that bisects the tear panel main portion and extends through the rivet, the hinge being offset relative to the main reference line;
a transverse reference line that is perpendicular to the main reference line and extends through the rivet, the main portion of the tear panel being located in front of the transverse reference line; and
a score including an arcuate main score that defines the main portion of the tear panel and a score extension that defines the vent portion, a first end of the score (i) defines one end of the hinge and (ii) is located on the hinge-side of the main reference line and in front of the transverse reference line, a second end of the score (i) defines one end of the score extension and (ii) is located on the hinge-side of the main reference line and to the rear of the transverse reference line;
whereby the score is configured such that actuation of the tab from its horizontal rest position to an intermediate position ruptures the main score portion to pivot the tear panel main portion about the hinge and further actuation of the tab by twisting from the intermediate position ruptures the score extension.

2. The can end of claim 1, whereby the score extension defines an arc that generally corresponds to the path of the tab when twisted in the further actuation from the intermediate position.

3. The can end of claim 1, wherein the score is configured such that the actuation from the intermediate position is optional.

4. The can end of claim 1, wherein the main portion of the tear panel is elongated in a transverse direction.

5. The can end of claim 4, wherein the main portion of the tear panel has an aspect ratio of between 1.3 and 1.7.

6. The can end of claim 1, wherein the main reference line and the transverse reference line divide the center panel into first and second front quadrants and first and second rear quadrants, the score extending (i) from the score first end in the first front quadrant across to the main reference line near the rivet to extend into the second front quadrant, (ii) in an arcuate path in the second front quadrant, (iii) across the main reference line near the front-most portion of the center panel, (iv) in an arcuate path in the first front quadrant, (v) to an intermediate point located in the first front quadrant and defining an end of the hinge opposite the score first end.

7. The can end of claim 6, wherein the score extension extends from the intermediate point across the transverse reference line into the first rear quadrant.

8. The can end of claim 1, wherein the hinge is defined between the score first end and an intermediate point on the score at the base of the score extension.

9. The can end of claim 8, wherein the score extension is no longer than three times the length of the hinge.

10. The can end of claim 8, wherein the score extension is no longer than two times the hinge.

11. A method of opening a beverage can end comprising the steps of:
providing a beverage can including a can body and an end attached to the can body by a double seam; the can end including a peripheral wall, a center panel, and a tab attached to the center panel by a rivet; the center panel including a tear panel that is formed by a score and defining a main reference line that bisects a main portion of the tear panel;
lifting a heel of the tab from its initial, horizontal position to force a nose of the tab against the tear panel until the score ruptures and the tear panel main portion pivots about a hinge that extends from a first end of the score, the first end of the score being located in front of the main reference line and on the hinge-side of a transverse reference line; and
twisting, after the lifting step, the tab to rupture an extension of the score;
whereby the score is configured such that actuation of the tab from its horizontal position to an intermediate position ruptures the main score portion to open the tear panel main portion and further actuation of the tab by twisting from the intermediate position ruptures the score extension to open the panel vent portion.

12. The method of claim 11, whereby the score extension defines an arc that generally corresponds to the path of the tab when twisted in the further actuation from the intermediate position.

13. The method of claim 11, wherein the twisting step is optional.

14. The method of claim 11, wherein the hinge is defined between the score first end and an intermediate point on the score at the base of the score extension.

15. The method of claim 11, wherein the score extension is no longer than three times the length of the hinge.

16. The method of claim 11, wherein the score extension is no longer than two times the hinge.

17. The method of claim 11, wherein the main portion of the tear panel has an aspect ratio of between 1.3 and 1.7.

18. A system for forming a score in a beverage can end, the system comprising:
an upper score cap having a main score protrusion and a score extension protrusion;
a lower score cap having an uninterrupted anvil surface extending at least to the corresponding location of the score extension protrusion of the upper score cap;
whereby the upper score cap and the lower score cap are configured to press together such that the main score protrusion forms a main score in the beverage can end and the score extension protrusion forms a score extension in the beverage can end; and
whereby the main score and the score extension are configured such that actuation of a tab coupled to the can end from its horizontal position to an intermediate position ruptures the main score portion to open a tear panel main portion and further actuation of the tab by twisting from the intermediate position ruptures the score extension to open a panel vent portion.

19. The system of claim 18, whereby the score extension defines an arc that generally corresponds to the path of the tab when twisted in the further actuation from the intermediate position.
